(19) United States
(12) Patent Application Publication
(10) Pub. No.: US 2016/0292769 A1
(43) Pub. Date: Oct. 6, 2016

(54) SYSTEMS AND METHODS THAT EMPLOY ADAPTIVE MACHINE LEARNING TO PROVIDE RECOMMENDATIONS

(71) Applicant: Stitch Fix, Inc., San Francisco, CA (US)

(72) Inventors: Eric C. Colson, Los Gatos, CA (US); Bradley J. Klingenberg, San Mateo, CA (US); Jeffrey S. Magnusson, Half Moon Bay, CA (US); W. Joel Strait, San Francisco, CA (US)

(73) Assignee: STITCH FIX, INC., San Francisco, CA (US)

(21) Appl. No.: 14/674,641

(22) Filed: Mar. 31, 2015

(51) Int. Cl. G06Q 30/06; G06N 99/00; G06N 5/04; G06Q 10/08

(52) U.S. Cl. CPC G06Q 30/0631; G06Q 10/087; G06N 99/005; G06N 5/046

(57) ABSTRACT

Systems and methods described herein employ adaptive machine learning to provide recommendations to an entity that selects one or more items for a client from an item inventory. Client information, item information, and recommendation algorithms are stored and are accessible by a recommendation engine. The recommendation algorithms utilize the client information and the item information in different manners to identify different subsets of items recommended for a client. Information about two or more of the subsets of the items in the item inventory that are identified are selected for display to the entity tasked with selecting items for the client. Feedback information, including client, selection and/or coverage feedback information, is obtained and adaptive machine learning is used to modify the stored client information, the stored item information and/or stored recommendation algorithm(s), in dependence on the client feedback information, the selection feedback information and/or the coverage feedback information.

### BACKGROUND

Recommendations systems are becoming increasingly common in online sales and digital media sites. Such systems typically use information about a user's preferences and purchasing behavior to recommend content and/or goods in which the user may be interested. Such recommendations systems often present a user with recommended content and/or goods without the user having to explicitly request or look for the content and/or goods. In this way, content and/or goods of which the user may have been unaware, may be brought to the attention of the user, for purchase. However, existing recommendation systems often recommend certain content and/or goods that are inappropriate for and/or poorly matched to users. Additionally, users are typically not informed of why specific content and/or goods have been recommended for them, which may cause the users to not appreciate why the recommended content and/or goods may be of interest to them, and may cause users lose trust in such recommendation systems.

### BRIEF DESCRIPTION OF THE DRAWINGS

FIG. 1 illustrates a computer implemented system, according to an embodiment of the present technology that employs adaptive machine learning to provide recommendations.

FIG. 2 illustrates an example of the information that can be displayed to an entity tasked with selecting items from an item inventory for a client.

FIG. 3 is a high level flow diagram used to summarize methods, according to embodiments of the present technology, that employ adaptive machine learning to provide recommendations to entities that select items for clients from an item inventory.

FIG. 4 is a high level flow diagram that provides some additional details of how items can be selected for display at one of the steps introduced in FIG. 3, according to specific embodiments.

### DETAILED DESCRIPTION

In the following detailed description, reference is made to the accompanying drawings that form a part hereof, and in which is shown by way of illustration specific illustrative embodiments. It is to be understood that other embodiments may be utilized and that mechanical and electrical changes may be made. The following detailed description is, therefore, not to be taken in a limiting sense. In the description that follows, like numerals or reference designators will be used to refer to like parts or elements throughout. In addition, the first digit of a reference number identifies the drawing in which the reference number first appears.

Most existing recommendation systems are computer implemented, and once implemented, rely entirely on computer implemented algorithms to provide recommendations to users. However, while computers are excellent at analyzing structured data, computers are generally not very good at analyzing unstructured data. Further, while computers are excellent at implementing the algorithms that they are programmed to implement, computers are not very good at parsing through the results of multiple algorithms or appreciating that some algorithms provide better results than others for specific users. Additionally, recommendation systems typically provide recommendations directly to the people, also referred to as consumers or clients, that determine whether or not they would like to purchase the recommended content and/or goods, wherein such content and/or goods can more generally be referred to individually as an item or collectively as items. Certain embodiments of the present technology, which are described below, provide improvements over such existing recommendation systems.

Certain systems and methods described herein employ adaptive machine learning to provide recommendations to an entity that selects one or more items for a client from an item inventory. Client information, item information, and recommendation algorithms are stored and are accessible by a recommendation engine. The recommendation algorithms utilize the client information and the item information in different manners to identify different subsets of items recommended for a client. Information about two or more of the subsets of the items in the item inventory that are identified are selected for display to the entity tasked with selecting items for the client. Feedback information, including client, selection and/or coverage feedback information, is obtained and adaptive machine learning is used to modify the stored client information, the stored item information and/or the stored recommendation algorithm(s), in dependence on the client feedback information, the selection feedback information and/or the coverage feedback information.

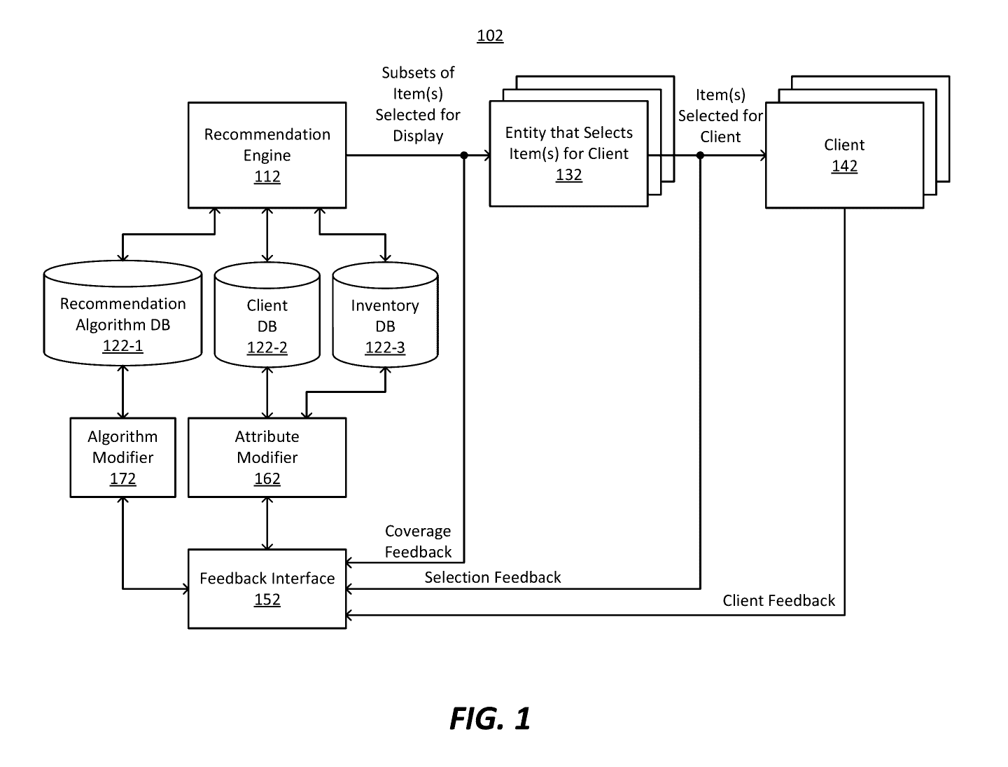

FIG. 1 illustrates a system 102, according to an embodiment of the present technology that employs adaptive machine learning to provide recommendations to entities that select items for clients from an item inventory, rather than providing the recommendations directly to the clients that determine whether or not they would like to purchase the recommended items. The system 102 is especially useful for assisting with tasks that are best performed by a combination of machines (e.g., computers) and humans. More specifically, the system 102 is especially useful for taking advantage of the fact that computers are typically better equipped to analyze or otherwise handle structured data, while humans are typically better equipped to analyze or otherwise handle unstructured data. Explain another way, embodiments described herein provide a mechanism to combine machine-learning algorithms with expert-human judgment, as will be appreciated from the description below.

Referring to FIG. 1, the system 102 is shown as including a recommendation engine 112 that is communicatively coupled to a recommendation algorithm database 122-1, a client database 122-2 and an inventory database 122-3. The databases 122-1, 122-2 and 122-3 can be individually referenced as a database 122, or collectively referenced as databases 122. Also shown in FIG. 1 are blocks 132, which represent entities that select one or more items for clients, and blocks 142, which represent the clients for with the item(s) is/are selected. Such entities 142 can be people that have an expertise related to the items included in the item inventory. FIG. 1 also shows a feedback interface 152 that accepts various types of feedback, including client feedback, selection feedback and coverage feedback, each of which is discussed in additional detail below. The feedback interface 152 is shown as being communicatively coupled to an attribute modifier 162 and an algorithm modifier 172. As will be described in additional detail below, in accordance with an embodiment the attribute modifier 162 is adapted to employ adaptive machine learning to modify, in dependence on client feedback received by the feedback interface 152, the client information stored in the client database 122-2 and/or the inventory information stored in the inventory database 122-3. In accordance with an embodiment, the algorithm modifier 172 is adapted to employ adaptive machine learning to modify, in dependence on selection feedback, coverage feedback and/or client feedback, recommendation algorithms stored in the recommendation algorithm database 122-1.

In accordance with an embodiment, the recommendation algorithm database 122-1 is adapted to store a plurality of different recommendation algorithms, each of which utilizes the client information and the item information in a different manner than the other algorithms to identify, for any particular one of the clients, a subset of the items in the item inventory that is recommended for the particular one of the clients. Such recommendation algorithms can also be referred to as recommendation rules, and the recommendation algorithm database 122-1 can similarly also be referred to as a recommendation rule database. The client database 122-2 is adapted to store client information, for each of a plurality of clients that indicates client attributes associated with each of the plurality of clients. The inventory database 122-3 is adapted to store item information, for each of a plurality of items included in an item inventory that indicates item attributes associated with each of the plurality of items included in the item inventory. In accordance with an embodiment, clients are people that have requested that items be selected for them and provided (e.g., mailed, shipped, sent or otherwise provided) to them.

The items in the item inventory can be, for example, women's apparel, with each item in the item inventory corresponding to a different piece of women's apparel. For a more specific example, the items in the item inventory can include pants, skirts, dresses, shirts, sweaters, jackets, bracelets, necklaces, scarfs, hats and/or the like. The item information stored in the inventory database 122-3 can include, for each of the items in the item inventory, a plurality of item attributes. Some of the items attributes can be objective attributes, while other attributes can be subjective attributes. Exemplary objective item attributes include: an item type (e.g., pant, skirt, dress, etc.), an item designer and/or brand, an item size, an item color, an item stock keeping unit (SKU) number, an item pattern (e.g., solid, checked, pinstripe, etc.), an item material (e.g., cotton, wool, synthetic, etc.), and/or the like. Exemplary subjective item attributes include: good for tall women, good for short women, good for busty women, good for women in the State of Texas, good for preppy women, good for women in their 20s, good for women in their 50s, good for women with a long torso, casual, dressy, good for tropical vacations, good for spring, good for winter, fits true to size, runs small, runs large, and/or the like. Subjective items attributes may also specify for which one or more body types (e.g., straight, pear, spoon, hourglass, top hourglass, inverted triangle, oval, diamond, etc.) an item is appropriate. At least some of the objective items attributes can be automatically entered into the inventory database 122-3, while other objective item attributes can be manually entered into the inventory database 122-3. In accordance with an embodiment, the subjective item attributes are specified by entities (e.g., people) that have an expertise in the type of items included in the inventory and are manually entered into the inventory database 122-3. The item inventory can also specify how many units of each item are presently in the item inventory. Additionally, the item inventory can specify how many units of each item have been ordered, as well as when ordered items are expected to be received to replenish the item inventory. Item attributes can also specify how often an item has been provided to clients, how often the item has been accepted (e.g., purchased) by clients and/or how often the item, once provided to clients, has been accepted (e.g., purchased) by clients. These are just some examples of the types of items attributes that can be stored in the inventory database 122-3, which examples are not intended to be all encompassing. At least some of the item attributes, or more generally at least a portion of the stored item information, for each of the items in the item inventory, is initially at least partly based on inputs accepted from an entity that is tasked with specifying item attributes. For example, a web based user interface can be presented to an entity that enables them to enter objective and subjective information about items, e.g., in response to questions or the like.

The client information stored in the client database 122-2 can include client attributes associated with each of a plurality of clients. Some of the client attributes can be objective attributes, while other attributes can be subjective attributes. Exemplary objective client attributes include: date of birth and/or age, height, weight, waist size, chest size, bra size, inseam length, torso length, shirt size, dress size, pant size, residential address, whether or not the client is a mother, occupation, and/or the like. Exemplary subjective client attributes include: preferred style (e.g., classic, preppy, casual, bohemian, etc.), preferred fit (e.g., loose, fitted, tight, etc.), preferred color scheme (e.g., bright, subdued), preferred patterns (e.g., solids, stripes, floral), and/or the like. Subjective client attributes can also specify to what extent a client likes specific styles, such as, but not limited to, casual, edgy, bohemian, classic, glamorous, preppy, romantic, and/or the like. Subjective client attributes can be binary (e.g., no or yes, or 0 or 1), or can have greater levels of granularity (e.g., a number between 0 and 5, with 5 indicating the greatest preference). Subjective client attributes can also specify to what extent a client likes specific designers and/or brands. Subjective client attributes may also specify how much a client indicates they are willing to spend on specific types of items. Another exemplary client attribute is body type (e.g., straight, pear, spoon, hourglass, top hourglass, inverted triangle, oval, diamond, etc.). Additionally, the client information associated with a particular client can also specify how long the particular client has been a member of the recommendation service provided by the system 102, how often items have been shipped to the client, which items were purchased or otherwise accepted by the client, which items were returned or otherwise not accepted by the client, and/or the like, each of which are further examples of objective client attributes. Objective client attributes may also specify how much a client has actually spent on specific types of items. These are just some examples of the types of client attributes that can be stored in the client database 122-2, which examples are not intended to be all encompassing. In an embodiment, at least some of the client attributes, or more generally at least a portion of the stored client information, for each of the clients, is initially at least partly based on inputs accepted from the client. For example, a web based user interface can be presented to a client that enables the client to enter objective and subjective information about themselves, e.g., in response to questions or the like.

In various embodiments, the recommendation engine 112 is adapt to identify a plurality of different subsets of the items in the item inventory that are recommended for any particular one of the clients by using all or some (i.e., each of two or more) of the plurality of different recommendation algorithms (stored in the recommendation algorithm database 122-1) to generate a different subset of the items in the inventory that is recommended for the particular one of the clients. Such identified subsets of the items in the inventory can be displayed to the specific entity 132 (e.g., a person) that is tasked with selecting items from the item inventory for the particular one of the clients. Accordingly, the recommendation engine 112 can be used to parse through data about a relatively large group of items included in an item inventory, and narrow the relatively large group down to a relatively smaller group, and thereafter a person can use their expert human judgment to select items from the relatively smaller group to provide (e.g., mail, ship, send or otherwise provide) to a client.

Assume, for example, that a particular entity 132 is tasked with selecting five items to send to a particular client 142. Where the number of items included in an inventory is relatively large, and there is a relatively large number of different recommendation algorithms (stored in the recommendation algorithm database 122-1), the entity tasked with selecting items from the item inventory for one of the clients may be overwhelmed. For example, assume that there are ten thousand different items in the item inventory, and that there are one hundred different recommendation algorithms stored in the recommendation algorithm database 122-1. Further, assume that each of the different subsets of the items (identified by the recommendation engine 112, using one of the recommendation algorithms) includes six items. Each of the subsets of items need not be mutually exclusive, e.g., it is possible that two different subsets of items, identified using two different recommendation algorithms, may be the same, but that is highly unlikely. However, there is a greater likelihood that an individual item may be included in more than one of the different subsets of items. Continuing with this example, and assuming that every one of the one hundred different recommendation algorithms is utilized by the recommendation engine 112, this would result in one hundred different subsets of six items being identified by the recommendation engine 112. In other words, in this example, information about six hundred items may be displayed the entity 132 tasked with selecting items from the item inventory for one of the clients 142. While narrowing ten thousand items down to six hundred items may be helpful, it is still likely that the entity tasked with selecting items from the item inventory for one of the clients would be overwhelmed, or would at least ignore many of the suggested items. Embodiments of the present technology, which are described herein, can be used to better assist the entity (tasked with selecting items from the item inventory for one of the clients) with making their selections for a client.

In accordance with an embodiment, each of the different recommendation algorithms included in the recommendation algorithm database 122-1 has a corresponding different theme. The themes associated with recommendation algorithms may or may not be related to specific client attributes. Exemplary themes that relate to specific client attributes include: good for tall women, good for short women, good for busty women, good for women in the state of Texas, good for preppy women, good for women in their 20s, good for women in their 50s, good for women with a long torso, casual selections, dressy selections, good for tropical vacations, good for spring, good for winter, good for women who like classic styles, good for women that like bohemian styles and/or the like. As can be appreciated from this exemplary list of themes, some of the themes (corresponding to recommendation algorithms) can be descriptors that are the same as or similar to descriptors of attributes associated with items in the item inventory. In accordance with an embodiment, for at least some of the themes, each theme (corresponding to a recommendation algorithm) indicates a common attribute associated with items selected using the recommendation algorithm. For example, the common attribute associated with items selected using the theme “good for tall women” is that all the items selected using the recommendation algorithm having that theme are believed to be good for women that are at least 5 feet 8 inches. For another example, the common attribute associated with items selected using the theme “good for women in the State of Texas” is that all the items selected using the recommendation algorithm having that theme are believed to be good for women that live in the State of Texas. Recommendation algorithms can be even more specific than those exemplary algorithms discussed above, or two or more recommendation algorithms can be compounded, e.g., to identify items that are “good for tall women in the State of Texas” or “good for preppy women in winter”. As algorithms, or combinations of algorithms become more specific, there coverage and level of confidence will likely decrease, in which case heuristics can be used to control a minimum coverage and/or confidence threshold.

Other themes can be more general and not specifically related to client attributes. For example, further exemplary themes of recommendation algorithms include: best sellers; highest probability of being purchased; highest profit margin; most similar to previously purchased items; least similar to previously purchased items; best for casual events; best for business events; good for fitting in; good for standing out; and/or the like. These are just a few examples that are not intended to be all encompassing. The types of recommendation algorithms and the themes associated therewith can vary greatly, depending upon the types of items in an item inventory and the clients for which items are being selected. Preferably, new recommendation algorithms can be added to the recommendation algorithm database 122-1 without affecting and/or requiring any specific coordination with the remaining portions of the system 102. This allows new algorithms to be tested and trained as desired, and poorly performing algorithms to be removed.

In accordance with an embodiment, the recommendation engine 112 is adapted to determine, for each of the recommendation algorithms having a theme that indicates a common attribute associate with items selected using the recommendation algorithm, whether or not any particular one of the clients satisfies the common attribute. Then, based on such determinations, the recommendation engine 112 can eliminate from being displayed, to an entity that is tasked with selecting items from the item inventory for the particular one of the clients, information about one or more of the subsets identified using any recommendation algorithm having a theme that indicates a common attribute not satisfied by the particular one of the clients. For example, where a particular client is a women that is 5 feet 1 inches tall and lives in the State of Oregon, the recommendation engine 112 can determine that the particular client does not satisfy the attributes “tall” and “living in the State of Texas”. Accordingly, the recommendation engine 112 can eliminate from being displayed, to an entity that is tasked with selecting items from the item inventory for that particular client, information about a subset of items believed to be good for tall women, and information about a subset of items believed to be good for women living in the State of Texas. One way that the recommendation engine 112 can do this is to not run the recommendation algorithm having the theme “good for tall women”, and not run the recommendation algorithm having the theme “good for women living in the State of Texas”. Alternatively, the recommendation engine 112 can run the recommendation algorithms having the themes “good for tall women” and “good for women living in the State of Texas”, but can ignore or hide the subsets of items identified using those algorithms, or rank or sort the subsets of items identified using those algorithms in such a manner that they will not be displayed. Other variations are also possible and within the scope of an embodiment.

One or more recommendation algorithms can calculate a distance or similarity metric between specific attributes associated with a client and specific attributes associated with items in an item inventory, with each distance or similarity metric being assigned a weight. Different recommendation algorithms may focus on different attributes and/or may weight distance or similarity metrics differently than one another. Additionally, or alternatively, different recommendation algorithms can use different ways to calculate the distance or similarity metrics between specific attributes associated with a client and corresponding attributes associated with items in an item inventory.

In accordance with an embodiment, the recommendation engine 112 is adapted to select for display, to an entity that is tasked with selecting items from the item inventory for the one of the clients, information about two or more of the plurality of different subsets of the items in the inventory that are identified by running all or some of the algorithms included in the recommendation algorithm database 122-1. In order to accomplish this task, the recommendation engine 112 can calculate, for each of at least some of the subsets of items identified using recommendation algorithms, one or more metrics that quantify one or more aspects of the subset of items. Exemplary metrics that quantify aspects of a subset of items include, but are not limit to, a metric indicative of probability of successfully (for making a sale), a metric indicative of profit, a metric indicative of similarity to previous items accepted by the one of the clients, a metric indicative of dissimilarity to previous items accepted by the one of the clients, a metric indicative of a probability of client satisfaction, a metric indicative of a probability of client retention, a metric indicative of optimally utilizing a company's inventory, a metric indicative of a cost of fulfilling a client's shipment and/or the like. The recommendation engine 112 can then sort at least some of the identified subsets of items, in dependence on at least one of the one or more calculated metrics, to produce a sorted subsets of items. The recommendation engine 112 can then use the sorted subsets of items to select for display information about two or more of the identified subsets of the items in the inventory.

In accordance with an embodiment, the information about two or more of the identified subsets of the items in the inventory can be displayed via a communication interface (e.g., a web browser) to an entity (represented by block 132 in FIG. 1) that is tasked with selecting items from the item inventory for one of the clients. This eliminates the need for any of the entities (represented by blocks 132 in FIG. 1) to obtain custom software to enable them to review recommended subsets of items (produced by the recommendation engine 112) in order to perform their job of selecting one or more items from the item inventory to be provided (e.g., shipped) to a client. In other words, each entity 132 can utilize a communications interface (e.g., a web browser) and a communication network (e.g., the Internet, a LAN, a WAN, a wireless network, an intranet, a private network, a public network, a switched network, combinations of these, and/or the like) to view subsets of items that are recommended for a particular client. In an alternative embodiment, the entities (represented by blocks 132 in FIG. 1) may use customized software to enable them to review recommended subsets of items (produced by the recommendation engine 112) in order to perform their job of selecting one or more items from the item inventory to be provided (e.g., shipped) to a client.

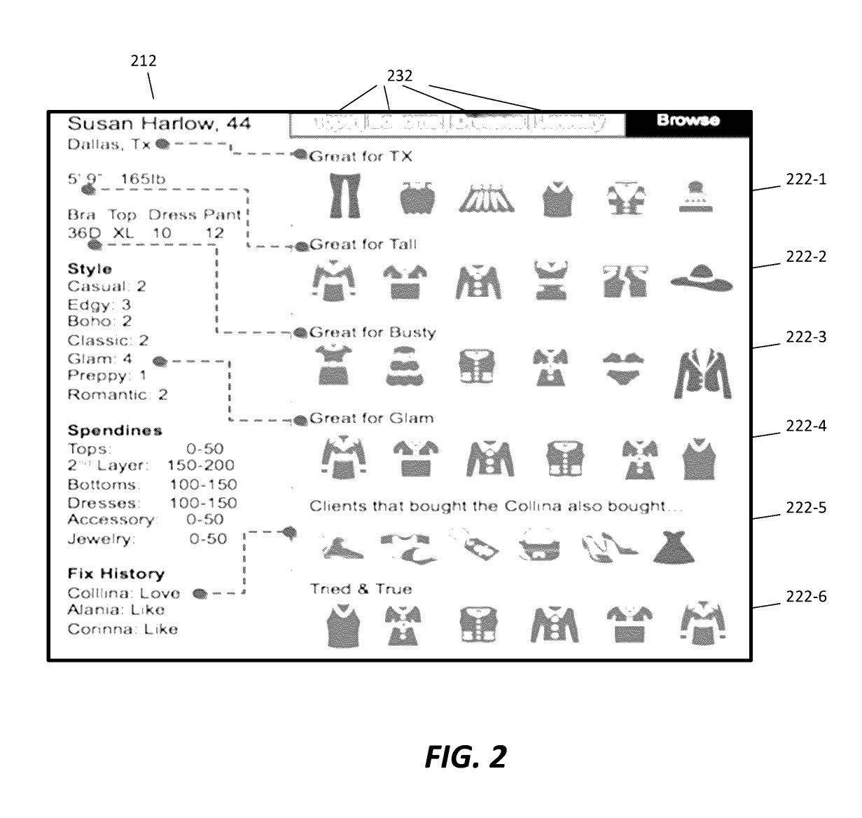

FIG. 2 will now be used to illustrate an example of the information that can be displayed to one of the entities 132 tasked with selecting items from the item inventory for one of the clients 142. For example, the information shown in FIG. 2 can be presented via a web page that is accessible via a web browser, but is not limited thereto. Referring to FIG. 2, attributes of a specific client are shown in the left most column 212, including: name, age, city and state of residence, bra size, top size, dress size and pant size. Other attributes included in the left most column 212 are information specifying to what extent the client likes specific styles, information specifying how much the client is willing to spend on various types of items of apparel, and historical information specifying to what extent the client has a preference for specific designers or brands. To the right of the left most column 212 are a number of rows 222-1, 222-2, 222-3, 222-4, 222-5 and 222-6, each of which can be referenced to as a row 222, and which collectively can be referenced as rows 222. Each of the rows 222 includes information about a different subset of items identified, by the recommendation engine 112, using a different one of the recommendation algorithms included in the recommendation algorithm database 122-1. Such displayed information can be textual and/or pictorial information. For example, in FIG. 2, each of the rows 222 includes thumbnails of six items in an identified subset of items. In an embodiment, additional pictures and/or other details about an item can be accessed by clicking on or otherwise selecting the thumbnail corresponding to the item. Each of the rows 222 is also shown as including the name of the theme of the recommendation algorithm that was used to select the subset of items included in the row. For example, the theme associated with the row 222-1 is “great for TX”, the theme associated with the row 222-2 is “great for tall”, the theme associated with the row 222-3 is “great for busty”, the theme associated with the row 222-4 is “great for glam” (where “glam” is short for glamourous), the theme associated with the row 222-5 indicates that clients that bought a particular brand (loved by this particular client) also bought . . . , and the theme associated with the row 222-6 is “tried & true”. Also shown in FIG. 2 are buttons 232 that enable an entity to filter the displayed items, e.g., such that if the “tops” button was selected, only tops would be displayed or highlighted in the rows 222.

In accordance with an embodiment, the recommendation engine 112 uses a row ordering algorithm to determine the order of the rows 222 shown in FIG. 2. Such a row ordering algorithm can use metrics, examples of which were mentioned above, to order the rows 222. A further algorithm, such as a relevancy algorithm, can be used to specify the order of the items in each row, e.g., so a most relevant item (of an identified subset of items) for a particular client is shown at the left most position in the row, and the least relevant item is shown at the right most position in the TOW.

In FIG. 2, items identified using the same recommendation algorithm are displayed within a same row, i.e., each row corresponds results produced using a same one of the recommendation algorithms. Alternatively, items identified using the same recommendation algorithm can be displayed within a same column, i.e., each column can correspond to one of the recommendation algorithms. More generally, inventory determined to be appropriate for a client can be divided into facets, with each facet representing a subset of items that is matched algorithmically to zero, one or more specific client attributes.

Referring back to FIG. 1, information about which subsets of items are displayed to the entities 132 tasked with selecting items for clients 142 is provided to the feedback interface 152, which information can be referred to as coverage feedback. Additionally, information about which items were selected by the entities 132 to provide to clients 142 is also provided to the feedback interface 142, which information is referred to as selection feedback. Additional types of feedback that can be collected and utilized include where individual items were presented within a row or column, which rows or columns did the entity (tasked with selecting items for a client) select from, which rows or columns were ignored. Such feedback information can be used, e.g., to calibrate the qualification, selection and/or sales rate for each subset of items, and/or the items therein.

After items are provided (e.g., shipped) to clients 142, each client determines what items they will keep or otherwise accept and which items they will return or otherwise reject. Information about which items particular clients accept and which items particular clients reject is also shown as being provided to the feedback interface, which information is referred to as client feedback. The client feedback can be entered by a client, or can be entered by some other entity, e.g., an entity that is responsible with tracking returned or otherwise unaccepted items. Other variations are also possible. For example, a client may provide explicit subjective feedback that specifies to what extent they were satisfied with particular items provided to them. Additionally, or alternatively, in certain embodiments clients can be asked to respond to survey questions, with answers to such question being another example of explicit subjective client feedback. More generally, a system (e.g., 102) can prompt a client (e.g., 142) to provide explicit subjective feedback for various different attributes associated with items selected for and provided to the client. Feedback can alternatively be considered implicit, in that it is based on one or more actions made by a client, e.g., whether or not a client accepted or returned (and thus rejected) an item.

The feedback interface 152 provides the feedback it receives, or information indicate thereof, to the attribute modifier 162 and/or the algorithm modifier 172. In accordance with an embodiment, the attribute modifier 162 receives client feedback information from the feedback interface 152, and the attribute modifier 162 employs adaptive machine learning to modify, in dependence on the client feedback information, the client information and/or the item information stored in the databases 122-2 and/or 122-3. For example, a client, via a user interface, may have initially indicated that they like apparel having a glamorous style, and dislike apparel having a casual style. However, despite the client's own opinion of their style preferences, the client may consistently purchase or otherwise accept apparel sent to them having a casual style, and consistently return or otherwise reject apparel sent to them having a classic style. In such a case, the client may have unintentionally mischaracterized their actual style preferences. Through such client feedback received by the feedback interface 152, the attribute modifier 162 may modify information stored within the client database 122-2 that specifies the style preferences of a client. For another example, if an item indicated as being “good for tall” women is repeatedly not accepted by tall women, but is repeated accepted by average height women, then the attribute modifier 162 may modify one or more attributes of that item so that the item is no longer associated with the attribute “good for tall”, but rather, has the attribute “good for average height”. For clarification, not all attributes are mutually exclusive. For example, an item may be both “good for tall” and “good for average height”.

As mentioned above, the recommendation engine 112 can calculate one or more metrics that quantify one or more aspects of a subset of items. Exemplary metrics that quantify aspects of a subset of items include, but are not limit to, a metric indicative of probability of successfully (for making a sale), a metric indicative of profit, a metric indicative of similarity to previous items accepted by a client, a metric indicative of dissimilarity to previous items accepted by a client and/or the like. Such metrics can be determined, using metric algorithms, in dependence on client information stored in the client database 122-2 and/or item information stored in the inventory database 122-2. In accordance with an embodiment, the algorithm modifier 172 can modify, in dependence on the client feedback, how one or more such metrics are calculated.

Attributes specified based on human judgment, by a client and/or expert-human, can be fallible, in contrast to empirical data. In accordance with specific embodiments, attributes specified by a human are adjusted as empirical data is collected, e.g., using the feedback interface 152. For example, a client may specify that they are “very” preppy, yet their purchase behavior may suggest that they are not preppy, but rather are very classic. The client attribute information, entered or otherwise specified by the client, can represent a prior value indicative of a client's preference. Stored information specifying the client's preferences can be modified over time as more and more empirical data is collected. For example, initially client specified attributes can be weighted very highly, and thereafter, as more empirical data is collected the client specified attributes can be weighted less and less, and the empirical data can be weighted more and more. Similar adjustments can be made to items attributes initially specified by human experts.

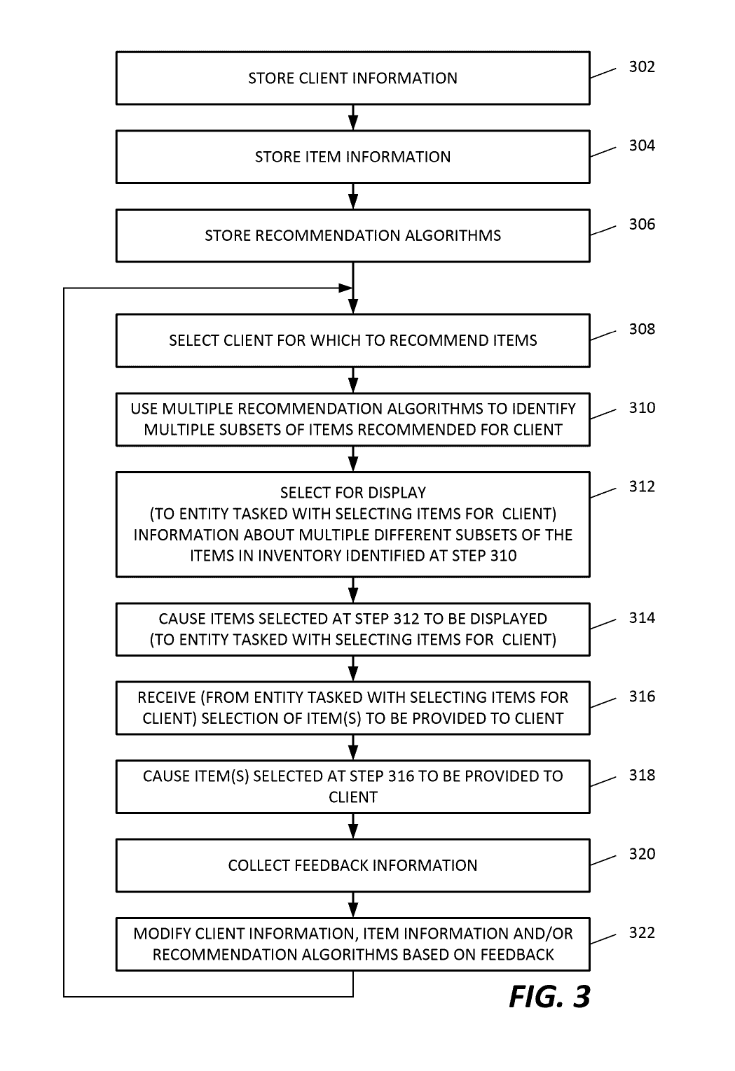

The high level flow diagram of FIG. 3 will now be used to summarize methods, according to embodiments of the present technology, that employ adaptive machine learning to provide recommendations to entities that select items for clients from an item inventory. Such methods provide a mechanism to combine machine-learning algorithms with expert-human judgment, to provide results that are better than can be achieved solely using machines or humans. Referring to FIG. 3, step 302 involves storing client information, for each of a plurality of clients, which indicates client attributes associated with each of the plurality of clients. Such client information can be stored, for example, in the client database 122-2 discussed above with reference to FIG. 1. Step 304 involves storing item information, for each of a plurality of items included in an item inventory, which indicates item attributes associated with each of the plurality of items included in the item inventory. Such item information can be stored, for example, in the inventory database 122-3 discussed above with reference to FIG. 1. Step 306 involves storing a plurality of different recommendation algorithms, each of which utilizes the client information and the item information in a different manner than the other algorithms, to identify, for any particular one of the clients, a subset of the items in the item inventory that is recommended for the particular one of the clients. Such recommendation algorithms can be stored, for example, in the recommendation algorithm database 122-1 discussed above with reference to FIG. 1. Exemplary client information (stored at step 302), exemplary item information (stored at step 304) and exemplary recommendation algorithms were discussed above with reference to FIG. 1, and thus, need not be repeated again.

Still referring to FIG. 3, step 308 involves selecting a client for which items are to be recommended. The clients can be selected, e.g., from a list or queue of clients that have indicated that they would like recommended items provided (e.g., shipped) to them. Depending upon the agreement between the client and the company responsible for providing the items to the client, the client may, for example, have the option of paying for items that they choose to keep or otherwise accept, and not paying for items that they choose to return or otherwise not accept.

Step 310 involves identifying a plurality of different subsets of the items in the item inventory that are recommended for the client (selected at step 308) by using each of two or more of the plurality of different recommendation algorithms to generate a different subset of the items in the inventory that is recommended for the client. Step 310 can be performed, for example, by the recommendation engine 112 discussed above with reference to FIG. 1, utilizing recommendation algorithms stored in the recommendation algorithm database 122-1. If there are a total of X recommendation algorithms in the recommendation algorithm database 122-1, then all X algorithms can be used and X subsets of items can be identified at step 310. Alternatively, only those recommendation algorithms that are deemed relevant or otherwise appropriate for the client may be performed. For example, if a client lives in the State of Oregon, then a recommendation algorithm having the theme “good for women in the State of Texas” may not be performed at step 310, or that algorithm may be performed and its results may be ignored at a later step (e.g., at step 312).

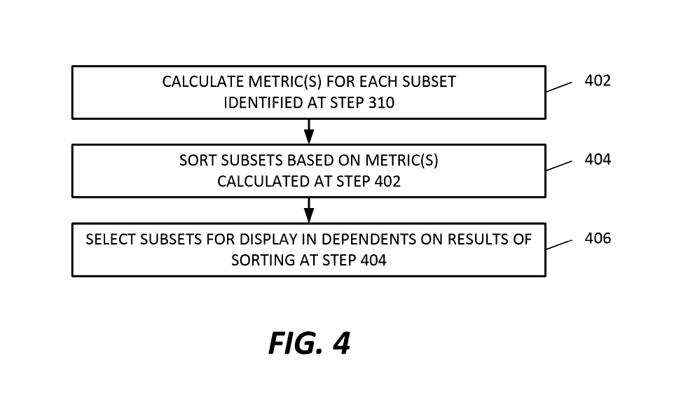

Step 312 involves selecting for display, to an entity that is tasked with selecting items from the item inventory for the client, information about two or more of the plurality of different subsets of the items in the inventory that are identified as a result of step 310. Step 312 can be performed, for example, by the recommendation engine 112 discussed above with reference to FIG. 1. Assume that X subsets of items were identified at step 310, and that X is a relatively large number (e.g., one hundred), and that each subset of items identified at step 310 includes Y items (e.g., Y equals six). Accordingly, as many as six hundred items could be identified at step 310, however that number may be slightly lower if there is an overlap of items within different subsets. Rather than displaying all six hundred items to the entity tasked with selecting items for the client, step 312 is performed to narrow down the items to be displayed to a more manageable number. For example, step 312 may involve selecting six subsets of six items each for display, such that information for a total of only thirty-six items are selected for display. Additional details of how to perform step 312, according to specific embodiments, are described below with reference to FIG. 4. In one embodiment, all of the items selected for display at step 312 can be simultaneously displayed at the same time on the same screen. In another embodiment, only a portion of the items selected for display at step 312 can be displayed at one time on the same screen, with other items selected for display being viewable by scrolling, paging down, or the like.

Step 314 involves causing the items, selected at step 312, to be displayed to the entity tasked with selecting items for the client. Step 314 can include, for example, generating a web page that resembles what is shown in FIG. 2 discussed above. The information about different subsets of the items in the inventory, that is caused to be displayed at step 314, can include textual and/or pictorial information different subsets of the items in the inventory that are identified as a result of step 312, as was described above with reference to FIG. 2.

Step 316 involves receiving, from the entity tasked with selecting items for the client, selections of items to be provided to the client. Steps 310, 312, 314 and 316 provide a mechanism where computers are relied upon to analyze structured data, and expert-human judgment is used to analyze unstructured data, and more generally, to improve upon results that can be achieved solely using a computer. In certain embodiments, each of the different recommendation algorithms has a corresponding different theme, and the information about each of the different subsets of the items in the inventory that is caused to be displayed, also include textual and/or pictorial information about the theme of the recommendation algorithm that was used to select the subset of items. Items included in a same subset of items, that are caused to be displayed at step 318, are caused to be displayed in one of a same row or a same column.

Step 318 involves causing items, selected at step 316 for a client, to be provided (e.g., shipped) to the client. Where selected item(s) are shipped to the client, identifiers (e.g., SKUs) of selected items can be provided to a computer and/or person at a warehouse that maintains the inventory. Selected items can be automatically and/or manually picked from the inventory and shipped to the client. Where selected items (e.g., digital movies or digital music) are electronically provided to the client, the selected items can be transmitted to the client.

Step 320 involves collecting feedback information, which can include, e.g., client feedback, selection feedback, and coverage feedback. As was described above with reference to FIG. 1, such feedback information may be received by the feedback interface 152. Step 322 involves modifying, in dependence on the feedback information obtained at step 322, client information (e.g., stored in the client database 122-2), item information (e.g., stored in the inventory database 122-3) and/or recommendation algorithms (e.g., stored in the recommendation algorithm database 122-1). This can include, for example, employing adaptive machine learning to modify, in dependence on the client feedback information received at instances of step 320, stored subjective client information and/or the stored subjective item information, so that further instances of step 310 utilize the modified stored client information and/or item information. Additionally, or alternatively, this can include employing adaptive machine learning to modify recommendation algorithms in dependence on client feedback information, selection feedback information and/or coverage feedback information, so that further instances of step 310 utilize the modified recommendation algorithms. For example, such various types of feedback information can be used to train the recommendation algorithms. In an embodiment, coverage feedback information is indicative of which items are caused to be displayed to the entity that is tasked with selecting one or more items from the item inventory for a client. In an embodiment, selection feedback information is indicative of the items selected by the entity that is tasked with selecting one or more items from the item inventory for the client. In an embodiment, client feedback can specify which items were purchased or otherwise accepted by a client and which items were returned or otherwise not accepted by the client. Further types of client feedback can also be accepted and used to modify client information, item information and/or recommendation algorithms. For example, clients may specify more particularly what they like and/or don't like about specific items, as part of the client feedback. Further exemplary details of such various types of feedback information were discussed above with reference to FIG. 1, and more specifically, in the discussion of the feedback interface 153. Such feedback information is an example of empirical data that can be used to train the recommendation algorithms using adaptive machine learning.

When a new item is added to the item inventory, there is initially no feedback information for the new item that is available for use by recommendation algorithms. This can be referred to as a “cold-start” problem. In accordance with specific embodiments, in order to mitigate the cold-start problem, one or more expert-humans are used to specify attributes of the new item, which attributes can be binary, categorical or ordinal. For example, whether an item is appropriate for tall women, is a binary attribute. For another example, how appropriate an item is for clients that describe themselves as having a bohemian style can be an ordinal attribute. For still another example, what body type is an item appropriate for can be a categorical attribute. Item attributes specified by expert-humans can be stored (e.g., in the inventory database 122-3) and associated with items. In order to reduce variance and increase robustness, judgments by many human-experts can be aggregated.

FIG. 4 will now be used to provide some additional details of how items can be selected for display at step 312, according to specific embodiments. In other words, FIG. 4 is used to provide some exemplary details of step 312. Referring to FIG. 4, step 402 involves calculating, for each of the subsets (or at least some of the subsets) of items identified at step 310 (using recommendation algorithms), one or more metrics that quantify one or more aspects of the subset of items. Exemplary metrics include, but are not limited to, a metric indicative of probability of success, a metric indicative of profit, a metric indicative of similarity to previous items accepted by the one of the clients and/or a metric indicative of dissimilarity to previous items accepted by the one of the clients. Step 404 involves sorting the subsets of items (or at least some of the subsets of items) identified at step 310 (using recommendation algorithms), in dependence on results of step 402. For example, where only one metric is determined for each subset at step 402, the subset with the highest value of that metric can be first, the subset with the second highest value of that metric can be second, etc. Where multiple metrics are determined for each subset at step 402, the metrics can be averaged, added or otherwise combined, to produce a combined value, and the subset with the highest combined value can be first, the subset with the second highest combined value can be second, etc. Where multiple metrics are combined, they can all be weighted the same, or some metrics can be weighted higher than others, depending upon implementation. Finally, step 406 involves selecting for display, in dependence on results of the sorting at step 404, the information about two or more of the plurality of different subsets of the items in the inventory that were identified at step 310. For example, at step 406 the top six (or some other number of) subsets can be selected for display, as was the case in FIG. 2, where each row in FIG. 2 corresponds to a different subset of items. FIG. 4 is used to summarize just one exemplary algorithm, which can be referred to as a meta-algorithm, that can be used (at step 312) to select which items identified using the recommendation algorithms (at step 310) are to be shared with an entity tasked with selecting items to be provided to a client. The use of alternative meta-algorithms are possible and with the scope of embodiments described herein.

Referring briefly back to FIG. 3, each of the different recommendation algorithms utilized at step 310 can have a corresponding different theme, as was discussed above with reference to FIG. 1. Each of (or some of) the different themes can indicate a common attribute associated with items selected using the recommendation algorithm associated with the theme. Referring again to FIG. 3, in accordance with certain embodiments, at step 312, for each of the recommendation algorithms having a theme that indicates a common attribute associate with items selected using the recommendation algorithm, there is a determination of whether or not a particular one of the clients satisfies the common attribute. If a client does not satisfy the common attribute associated with the theme of a recommendation algorithm, then a subset of items identified (or that would be identified) using the recommendation algorithm is eliminated from being displayed to the entity tasked with selecting items from the item inventory for the client.

In many of the examples described above, the items in the item inventory were described as being women's apparel, and the systems and methods were described as employing adaptive machine learning to recommend subsets of women's apparel to an entity that selects one or more pieces of women's apparel to send or otherwise provide to a client. However, embodiments of the present technology are not limited to such types of items, and more generally, can be used for recommending almost any type of item that would benefit from combining machine-learning algorithms with expert-human judgment. For example, the items in the item inventory can alternatively be men's apparel, food, wine, beer, artwork, music or movies, just to name a few. Depending upon the type of items, certain types of items that are selected for a client can be provided to a client by delivering, mailing or shipping the items to the client, while other types of items can be delivered electronically over wired or wireless communication networks. Preferably, the entity that is tasked with selecting items for a client, based on recommendations generated using more or more computers, has an acceptable level of expertise in the type of items included in the item inventory. For example, where the items are women's apparel, the entity that select which items to be sent to a client may have studied fashion, worked in fashion, and/or worked in clothing retail. For another example, where the items are wine, the entity that selects which items are to be sent to a client may be a sommelier, a wine collector or have worked for a vineyard. These are just a few examples that are not intended to be all encompassing.

The items in an item inventory need not be physical products. For example, the items in an item inventory can alternatively be insurance policies. In other words, embodiments of the present technology can be used to select insurance policies for clients. For another example, the items in an item inventory can be travel packages, in which case embodiments of the present technology can be used to select travel packages for clients. It is also possible that the items in an item inventory are applicants for a job, in which case, embodiments of the present technology can be used to help sift through resumes, or the like, to select specific prospective hires for clients. For still another example, the items in an item inventory can be student applicants, in which case, embodiments of the present technology can be used to help sift through school applications to select which student applicants should be accepted to a school. These are just a few examples, which are not intended to be all encompassing. More generally, embodiments described herein are especially useful for providing recommendations in domains where: (1) there are numerous choices available to select from for a client; (2) the products or services (or more generally, the items) need to be personalized for a client; (3) there exists both structured and unstructured data about the items and/or clients, which would benefit from a combination of machine-learning algorithms and expert-human judgment (e.g., so machines can handle the structured data, and expert-humans can handle the unstructured data); and (4) a client is given an opportunity to try selected items and provide feedback regarding what they like and don't like about the items they tried. As noted above, the types of recommendation algorithms and the themes associated therewith can vary greatly, depending upon the types of items in an item inventory and the clients for which items are being selected.

The subject matter described herein may be embodied in systems, apparatus, methods, and/or articles depending on the desired configuration. In particular, various implementations of the subject matter described herein may be realized in computer software, firmware or hardware and/or combinations thereof, as well as in digital electronic circuitry, integrated circuitry, and the like. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, applications, components, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs), but not limited thereto) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a cathode ray tube (CRT) or liquid crystal display (LCD) monitor, but not limited thereto) for displaying information to the user and a keyboard, touch screen and/or a pointing device (e.g., a mouse, touchpad or a trackball, but not limited thereto) by which the user may provide input to the computer. Other kinds of devices may be used to provide for interaction with a user, administrator and/or manager as well; for example, feedback provided to the user, administrator and/or manager may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface (GUI) or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include, but are not limited to, a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Wherever possible, the same reference numbers will be used throughout the drawings to refer to the same or like parts.

While various embodiments of the present invention have been described above, it should be understood that they have been presented by way of example, and not limitation. It will be apparent to persons skilled in the relevant art that various changes in form and detail can be made therein without departing from the spirit and scope of the invention. For example, although a few variations have been described in detail above, other modifications or additions are possible. In particular, further features and/or variations may be provided in addition to those set forth herein. For example, the implementations described above may be directed to various combinations and sub-combinations of the disclosed features and/or combinations and sub-combinations of several further features disclosed above. In addition, the logic flow depicted in the accompanying figures and/or described herein do not require the particular order shown, or sequential order, to achieve desirable results. Other embodiments may be within the scope of the following claims.

Embodiments of the present invention have been described above with the aid of functional building blocks illustrating the performance of specified functions and relationships thereof. The boundaries of these functional building blocks have often been defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof.

The breadth and scope of the present invention should not be limited by any of the above-described exemplary embodiments, but should be defined only in accordance with the following claims and their equivalents.

What is claimed is:

1. A method that employs adaptive machine learning to provide recommendations to entities that select items for clients from an item inventory, the method comprising:
(a) storing client information, for each of a plurality of clients, that indicates client attributes associated with each of the plurality of clients;
(b) storing item information, for each of a plurality of items included in an item inventory, that indicates item attributes associated with each of the plurality of items included in the item inventory;
(c) storing a plurality of different recommendation algorithms each of which utilizes the client information and the item information in a different manner than the other algorithms to identify, for any particular one of the clients, a subset of the items in the item inventory that is recommended for the particular one of the clients;
performing the following steps (d), (e) and (f) for each client of two or more of the clients
(d) identifying a plurality of different subsets of the items in the item inventory that are recommended for one of the clients by using each of two or more of the plurality of different recommendation algorithms to generate a different subset of the items in the inventory that is recommended for the one of the clients;
(e) selecting for display, to an entity that is tasked with selecting items from the item inventory for the one of the clients, information about two or more of the plurality of different subsets of the items in the inventory that are identified as a result of the identifying step; and
(f) receiving client feedback information from the one or more of the clients; and
(g) employing adaptive machine learning to modify, in dependence on the client feedback information received at instances of the receiving client feedback step (f), at least one of the stored client information or the stored item information, so that further instances of the identifying step (d) utilize the modified at least one of the stored client information or the stored item information.

2. The method of claim 1, wherein the step (e) of selecting for display includes:
(e.1) calculating, for each of at least some of the subsets of items identified as a result of the identifying step, one or more metrics that quantify one or more aspects of a said subset of items;
(e.2) sorting at least some of the subsets of items, identified as a result of the identifying step, in dependence on results of the calculating step; and
(e.3) selecting for display, in dependence on results of the sorting step, the information about two or more of the plurality of different subsets of the items in the inventory that are identified as a result of the identifying step.

3. The method of claim 2, wherein the one or more metrics that quantify one or more aspects of a said subset of items comprise at least one of the following:
a metric indicative of probability of success;
a metric indicative of profit;
a metric indicative of similarity to previous items accepted by the one of the clients;
a metric indicative of dissimilarity to previous items accepted by the one of the clients;
a metric indicative of a probability of client satisfaction;
a metric indicative of a probability of client retention;
a metric indicative of optimally utilizing an item inventory; or
a metric indicative of a cost of fulfilling a client's shipment.

4. The method of claim 2, wherein:
each of the different recommendation algorithms has a corresponding different theme;
each of at least some of the different themes, corresponding to at least some of the different recommendation algorithms, indicates a common attribute associated with items selected using the recommendation algorithm;
step (e) further comprises
for each of the recommendation algorithms having a theme that indicates a common attribute associate with items selected using the recommendation algorithm, determining whether or not the one of the clients satisfies the common attribute; and
eliminating from being displayed, to an entity that is tasked with selecting items from the item inventory for the one of the clients, information about one or more of the subsets identified using a said recommendation algorithm having a theme that indicates a said common attribute not satisfied by the one of the clients.

5. The method of claim 2, further comprising employing adaptive machine learning to modify, in dependence on the client feedback, how at least one of the one or more metrics is/are calculated at instances of step (e).

6. The method of claim 1, wherein each instance of the client feedback information received at step (f) indicates which one or more items selected for the client were rejected by the client, if any, and which one or more items selected for the client were accepted by the client, if any.

7. The method of claim 1, wherein for one of the clients, between an instance of step (e) and an instance of step (f), the following occurs:
causing displaying, to the entity that is tasked with selecting one or more items from the item inventory for the one of the clients, information about the two or more of the plurality of different subsets of the items in the inventory;
receiving, from the entity that is tasked with selecting items from the item inventory for the one of the clients, a selection of one or more items to be provided to the one of the clients; and
causing the one or more items, selected by the entity that is tasked with selecting one or more items from the item inventory for the one of the clients, to be provided to the one of the clients.

8. The method of claim 7, further comprising:
receiving coverage feedback information which is indicative of which items are caused to be displayed to the entity that is tasked with selecting one or more items from the item inventory for the one of the clients;
receiving selection feedback information which is indicative of the items selected by the entity that is tasked with selecting one or more items from the item inventory for the one of the clients; and
employing adaptive machine learning to modify, in dependence on at least one of the coverage feedback information or the selection feedback information, at least one of the stored recommendation algorithms, so that further instances of the identifying step utilize the modified at least one of the stored recommendation algorithms.

9. The method of claim 7, wherein the information about the two or more of the plurality of different subsets of the items in the inventory, that is caused to be displayed, comprises at least one of textual or pictorial information about the two or more of the plurality of different subsets of the items in the inventory that are identified as a result of the identifying step (d).

10. The method of claim 9, wherein each of different recommendation algorithms has a corresponding different theme, and wherein the information about the two or more of the plurality of different subsets of the items in the inventory, that is caused to be displayed, also comprises at least one of textual or pictorial information about the theme of the recommendation algorithm that was used to select the subset of items.

11. The method of claim 10, wherein items included in a same subset of items, of the two or more of the plurality of different subsets of the items in the inventory that are caused to be displayed, are caused to be displayed in one of a same row or a same column.

12. The method of claim 1, wherein:
one or more of the client attributes, indicated by the stored client information, is/are objective client attributes;
one or more of the client attributes, indicated by the stored client information, is/are subjective client attributes;
one or more of the item attributes, indicated by the stored item information, is/are objective item attributes; and
one or more of the item attributes, indicated by the stored item information, is/are subjective item attributes; and
the step (e) of employing adaptive machine learning is used to modify, in dependence on the client feedback information received at instances of receiving client feedback step (f), at least one of the subjective client attribute(s) and/or at least one of the subjective item attribute(s).

13. A method that employs adaptive machine learning to provide recommendations to an entity that selects one or more items for a client from an item inventory, the method comprising:
accessing stored client information that indicates client attributes associated with the client;
accessing stored item information, for each of a plurality of items included in an item inventory, that indicates item attributes associated with each of the plurality of items included in the item inventory;
accessing stored recommendation algorithms each of which utilizes the client information and the item information in a different manner than the other algorithms to identify a subset of the items in the item inventory that is recommended for the client;
identifying a plurality of different subsets of the items in the item inventory that are recommended for the client by using each of two or more of the plurality of different recommendation algorithms to generate a different subset of the items in the inventory that is recommended for the client;
selecting for display, to the entity that is tasked with selecting items from the item inventory for the client, information about two or more of the plurality of different subsets of the items in the inventory that are identified as a result of the identifying step;
obtaining feedback information including client feedback information, selection feedback information and coverage feedback information; and
employing adaptive machine learning to modify the stored client information, the stored item information and at least one of the stored recommendation algorithms, in dependence on the client feedback information, the selection feedback information and the coverage feedback information.

14. The method of claim 13, further comprising, between the selecting for display, and the obtaining feedback information:
causing displaying, to the entity that is tasked with selecting one or more items from the item inventory for the client, information about the two or more of the plurality of different subsets of the items in the inventory;
receiving, from the entity that is tasked with selecting items from the item inventory for the client, a selection of one or more items to be provided to the client; and
causing the one or more items, selected by the entity that is tasked with selecting one or more items from the item inventory for the client, to be provided the client.

15. The method of claim 13, wherein each of the recommendation algorithms calculates a distance or similarity metric between specific attributes associated with the client and specific attributes associated with items in an item inventory, with each distance or similarity metric being assigned a weight.

16. A system that employs adaptive machine learning to provide recommendations to entities that select items for clients from an item inventory, the system comprising:
one or more databases adapted to store client information, for each of a plurality of clients, that indicates client attributes associated with each of the plurality of clients;
item information, for each of a plurality of items included in an item inventory, that indicates item attributes associated with each of the plurality of items included in the item inventory;
a plurality of different recommendation algorithms each of which utilizes the client information and the item information in a different manner than the other algorithms to identify, for any particular one of the clients, a subset of the items in the item inventory that is recommended for the particular one of the clients;
a recommendation engine adapt to
identify a plurality of different subsets of the items in the item inventory that are recommended for any particular one of the clients by using each of two or more of the plurality of different recommendation algorithms to generate a different subset of the items in the inventory that is recommended for the particular one of the clients; and
select for display, to an entity that is tasked with selecting items from the item inventory for the particular one of the clients, information about two or more of the plurality of different identified subsets of the items in the inventory;
a feedback interface adapted to receive client feedback information from one or more of the clients; and
an attribute modifier adapted to employ adaptive machine learning to modify, in dependence on the client feedback information received by the feedback interface, at least one of the client information or the item information stored in the one or more databases, which are used by the recommendation engine.

17. The system of claim 16, wherein, in order to select for display, the recommendation engine is adapted to
calculate, for each of at least some of the identified subsets of items, one or more metrics that quantify one or more aspects of a said subset of items;
sort at least some of the identified subsets of items, in dependence on at least one of the one or more calculated metrics, to produce a sorted subsets of items; and
use the sorted subsets of items to select for display the information about two or more of the identified subsets of the items in the inventory.

18. The system of claim 17, wherein the one or more metrics that quantify one or more aspects of a said subset of items comprise at least one of the following:
a metric indicative of probability of success;
a metric indicative of profit;
a metric indicative of similarity to previous items accepted by the one of the clients;
a metric indicative of dissimilarity to previous items accepted by the one of the clients;
a metric indicative of a probability of client satisfaction;
a metric indicative of a probability of client retention;
a metric indicative of optimally utilizing an item inventory; or
a metric indicative of a cost of fulfilling a client's shipment.

19. The system of claim 17, wherein:
each of the different recommendation algorithms has a corresponding different theme;
each of at least some of the different themes, corresponding to at least some of the different recommendation algorithms, indicates a common attribute associated with items selected using the recommendation algorithm; and
the recommendation engine is adapted to
determine, for each of the recommendation algorithms having a theme that indicates a common attribute associate with items selected using the recommendation algorithm, whether or not any particular one of the clients satisfies the common attribute; and
eliminate from being displayed, to an entity that is tasked with selecting items from the item inventory for the particular one of the clients, information about one or more of the subsets identified using a said recommendation algorithm having a theme that indicates a said common attribute not satisfied by the particular one of the clients.

20. The system of claim 17, further comprising an algorithm modifier that is adapted to employ adaptive machine learning to modify, in dependence on the client feedback, how at least one of the one or more metrics is/are calculated by the recommendation engine.

21. The system of claim 16, wherein each instance of the client feedback information received by the feedback interface indicates which one or more items selected for a particular one of the clients were rejected by the particular one of the clients, if any, and which one or more items selected for the particular one of the clients were accepted by the particular one of the clients, if any.

22. The system of claim 16, wherein after the recommendation engine selects for display information about two or more of the plurality of different identified subsets of the items in the inventory, the following occurs:
information about the two or more of the plurality of different subsets of the items in the inventory is displayed to the entity that is tasked with selecting one or more items from the item inventory for the particular one of the clients;
the entity, that is tasked with selecting items from the item inventory for the particular one of the clients, selects one or more items to be provided to the particular one of the clients; and
the one or more items, selected by the entity that is tasked with selecting one or more items from the item inventory for the particular one of the clients, is caused to be provided to the particular one of the clients.

23. The system of claim 22, wherein:
the feedback interface is also adapted to receive coverage feedback information indicative of which items are displayed to the entity that is tasked with selecting one or more items from the item inventory for the particular one of the clients;
receive selection feedback information indicative of which of the items are selected by the entity that is tasked with selecting one or more items from the item inventory for the particular one of the clients; and
employ adaptive machine learning to modify, in dependence on at least one of the coverage feedback information or the selection feedback information, at least one of the stored recommendation algorithms.

24. The system of claim 22, wherein the information about the two or more of the plurality of different subsets of the items in the inventory, that is displayed, comprises at least one of textual or pictorial information about the two or more of the plurality of different subsets of the items in the inventory that are identified as a result of the identifying step.

25. The system of claim 24, wherein each of different recommendation algorithms has a corresponding different theme, and wherein the information about the two or more of the plurality of different subsets of the items in the inventory, that is caused to be displayed, also comprises at least one of textual or pictorial information about the theme of the recommendation algorithm that was used to select the subset of items.

26. The system of claim 25, wherein items included in a same subset of items, of the two or more of the plurality of different subsets of the items in the inventory that are caused to be displayed, are caused to be displayed in one of a same row or a same column.

27. The system of claim 16, wherein:
one or more of the client attributes, indicated by the stored client information, is/are objective client attributes;
one or more of the client attributes, indicated by the stored client information, is/are subjective client attributes;
one or more of the item attributes, indicated by the stored item information, is/are objective item attributes; and
one or more of the item attributes, indicated by the stored item information, is/are subjective item attributes; and
the attribute modifier is adapted to employ adaptive machine learning to modify, in dependence on the client feedback information, at least one of the subjective client attribute(s) and/or at least one of the subjective item attribute(s).
